(19) United States
(12) Patent Application Publication
(10) Pub. No.: US 2018/0087704 A1
(43) Pub. Date: Mar. 29, 2018

(54) Pipe Self Closing Device

(71) Applicant: Michael Rollins, Tucson, AZ (US)

(72) Inventor: Michael Rollins, Tucson, AZ (US)

(21) Appl. No.: 15/278,908

(22) Filed: Sep. 28, 2016

(51) Int. Cl. F16L 55/07

(52) U.S. Cl. CPC F16L 55/07

(57) ABSTRACT

The passage of a normal pipe draw has inserted into it a tube that be fitted by cutting off extra mass above the drain flange and at the bottom of the device has at least one hinge inside the tube that has at least one lid that opens when water or mass is placed upon it and it closes when the water or mass is removed to prevent and help reduce the access of insects/living creatures crawling through the pipe into the surface air.

### BACKGROUND OF THE INVENTION

This invention provides for the much needed help in trying to reduce and stop insects/living creatures from coming through the pipes into a person's home, dwelling, building, and the like. The investor hates insect, especially cockroaches, and during the year, especially the very warm summer months, the insects/living creatures crawl through the sewer pipes to finally exit by way of the pipe or drain flange, thus infecting people's home, residence, building, etc.

The inventor tried covering each of drains with covers, plastic plugs, strainers, and cups to prevent the insects/living creatures from clawing through into his home, however it was unsuccessful. It always seems if the pipe or drains had any opening, the insects/living creatures would find it. Plus, there was always the problem of forgetting recover the openings from the sink or drain after using it so the barrier was in place. Moreover, if any third party used the drain or pipes and forget to return the barrier the insects/living creatures were still able to invade the home, business, dwelling, or the like.

After much trial and error, inventor was invented the Pipe Self Closing Device that not only keep the insects/living creatures out of the home by having the lid automatically work as a barrier so they are not able to crawl out of the drain. This invention works on drains and pipes with pivotal rods to plug the water in the sink for cooking, restaurant and bathroom needs. The inventor kept his design very simple to insure it was easy to install, replace when worn or broken, and use on a regular basics as a daily tool to help stop insects/living creatures from entering people's homes, dwellings, buildings or the like, especially when they have been exposed to the disgusting sewer environment. After using his invention, the inventor did not used any insect exterminator companies or use any harmful insect killing sprays, traps, bait, or chemicals because the insects/living creatures were not able to invade the home, dwelling.

These insects/living creature carry diseases, bacteria, and germs with them and are extremely hard to get rid of do to their easy access of just crawling through the open drains, with their high breeding capabilities, thus giving rise to the multi-billion industry of manufacturing harmful insect sprays, poisons, baits, and traps that are solely designed to be a post-remedy of control method to these insects/living creatures that are already living and breading inside of the home. Moreover, insects/living creatures that have exposure to sewer can carry and transport diseases, bacteria and germs from the sewer into people's homes, dwellings, businesses and can affect people's health. This invention is a pre-control device to help stop or reduce the flow or amount of insects/living creatures before they crawl through the pipes. This invention has a tube that can be inserted into the pipe, the tube's length can be fitted by the customer as to his preference.

When enough mass (i.e. water mass, water) goes through the invention the lid at the bottom will open and let the water out and then it will close when pressure is removed. Once the invention closes again, the invention prevents any insects/living creatures from crawling through the drain pipe to the surface air because the lid prevents the passage.

### SUMMARY OF INVENTION

The summary of my invention is meant to provide a simple description in a very basic form that does not intend to detail essential features or assist in the determination of the scope of the claimed subject matter, nor is the summer of invention meant to identify the important attributes.

My invention is a device that reduces and/or stops insects/living creatures from passing to the surface by having a lid at the bottom that only opens when enough mass forces the hinge to open the lid and once the mass has removed itself due to gravity, the hinge closes the lid thus preventing the insects/living creatures from crawling up the drain pipe to the surface air. My invention can also help stop or bar objects from falling down the drain do to its smaller size in diameter than the pipe and the lid.

My invention can be used on drain pipes and cut to fit its length to be inserted into the drain flange. My invention can also be used in drain flanges that have pivotal rods, for the tube can be placed above the pivotal rod so when the pivotal rod is open the lid can open freely and when the rod is close the lid will be force to stay close, thus allowing the sink/bathtub to pool water and work normally. This invention works to reduce and/or stop insects/living creatures from crawling up the drain flange from the sewer by not being able to the pass the lid barrier.

### BRIEF DESCRIPTION OF DRAWINGS

The specific details, features, attributes, advantages, and aspects of the Pipe Self Closing Device described herein will be better understood with the inclusion of the following description of drawings (not to scale) the claims, and drawings set forth herein this application:

FIG. 1 is a drawing of the device from the its exterior and shows the device with its lid closed and at rest at the bottom of the tube.

FIG. 2 is a drawing of the device that shows a side view from that has the lid open at the bottom of the tube.

FIG. 3 is a drawing of the device from a transparent side view that demonstrates the hinge and the lid closed.

FIG. 4 is a drawing of the device from its side view, transparent, and demonstrates how the lid opens from the hinge once enough mass strikes the lid. (water is only for demonstrations purposes.)

FIG. 5 is a drawing of the device inside a pipe that has its lid closed by its hinge.

FIG. 6 is a drawing of the device from the inside a pipe and the lid is open because the mass is striking the lid has caused the hinge to open so the mass could flow out of the device.

FIG. 7 is a drawing of the device from the inside the pipe and its lid is close because the pivotal rod is bracing the lid closed.

FIG. 8 is a drawing of the device from inside a pipe drain and lid is open do enough mass sticking the while the pivotal rod is in the open position (water is only for demonstrations purposes.)

FIG. 9 is a drawing from the top centre of the device from inside a pipe drain of how the device fits securely into the pipe and the hinge to the lid is exposed.

FIG. 10 is a drawing of the device being installed into a pipe drain in which once the desired length of insertion is achieved the remaining plastic can be cut off/removed (scissors are only for demonstrations purposes.)

FIG. 11 is a drawing of the device with the tube that has two hinges connected to it and the two lids in the retracted position so the two lids are a barrier.

FIG. 12 is a drawing of the device with the tube that has two hinges connected to it and two lids in the extended position so the lids are open and not acting as a barrier.

FIG. 13 is a drawing of the device that is placed within the exit return pipe that has a closed lid that is attached to a bathtub.

FIG. 14. is a drawing of a device that is placed within the exit return pipe that has an open lid because the attached is draining out its waste water.

FIG. 15 is a drawing of the device inside the return pipe before the J-pipe connection that is attached to one or more sinks with return pipes that its lid is closed.

FIG. 16. is a drawing of the device inside the return pipe before the J-pipe connection that is attached to one or more sinks with return pipes that hasits lid open because waste water is being drained.

### DETAILED DESTRUCTION OF THE INVENTION

In the description below of the Pipe Self Closing Device embodiments reference is made to the following device drawings which are noticed herein by reference in which the device is able to used.

The term “lid” is used to describe the bottom barrier that can open and close at the base of the tube.

The term “tube” is used to describe a circular tube that can fit into a drain or pipe.

The term “spring” is used to describe an expandable mechanism that can open when enough pressure is placed on it and then close when the pressure is removed.

The term “waste water” is used to describe the water or dirty water or any waste that is drained from the sink/toilet/bathtub, and the like.

The term “pipe” is used to describe a hallow cylinder or tube that is used to allow or conduct waste water, water, liquid, gas, or small solid parts.

The term “drain flange” is used to describe the connection pipe that is normally connected to the start or beginning of the drain outlet pipe of the sink, toilet, bathtub, or the like, to the exit pipe or J-pipe part.

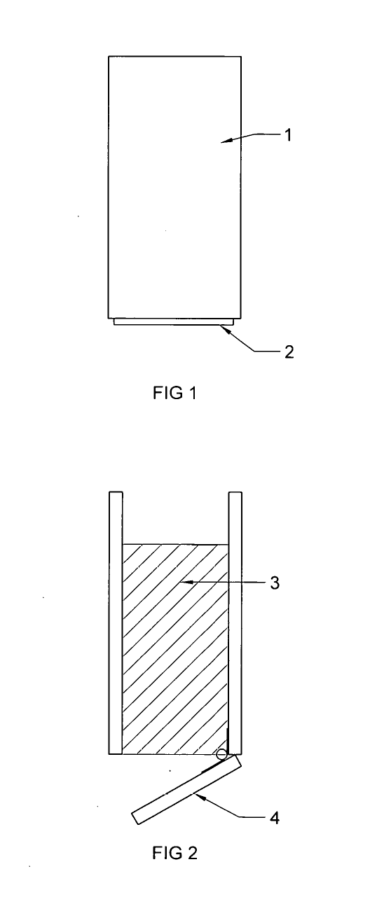

Referring to FIG. 1, a device for stopping and preventing insects/living creatures from crawling to the surface air through drains is comprised of one tube (1), and lid(s) (2), and internal hinge(s). FIG. 1 is an exterior view that demonstrates the tube (1) and lid (2) in the closed position.

Referring to FIG. 2, the devise has its tube (3) and lid (4) open to demonstrate the movement of the lid (4) from an exterior view in a transparent perspective.

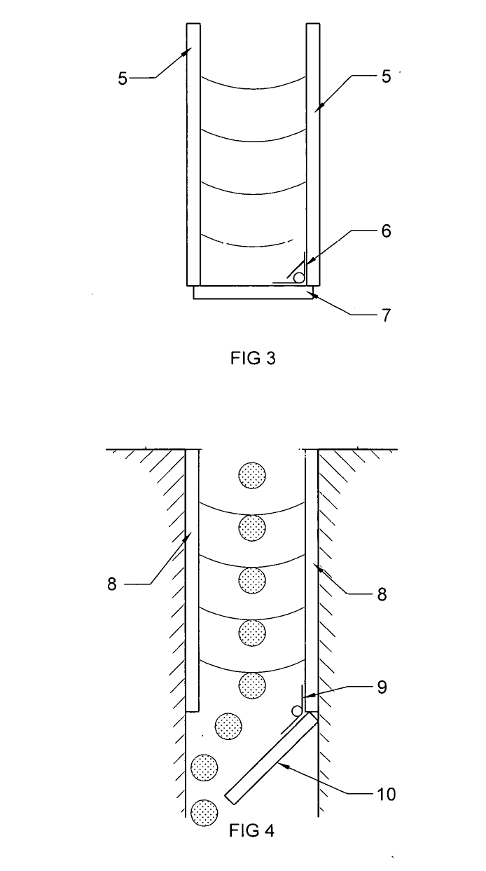

Referring to FIG. 3, a device is viewed from a transparent perspective, the tube (5) has an opening at the top and at the bottom of the tube (5) there is a lid (7) with an attached hinge (6) to both the tube (5) and the lid (7).

Referring to FIG. 4, the device has its tube (8) connected to its hinge (9) and the lid (10) while the hinge (9) is open so the lid (10) separates from the tube (8) to provide an opening. The water is for only demonstration in proposes.

Referring to FIG. 5, the device is placed inside of a drain flange or pipe and the tube (11) is at its desired length the hinge (12) will secure the the lid (13) in place and provide for a barrier to prevent insects/living creatures from continuing to the surface air.

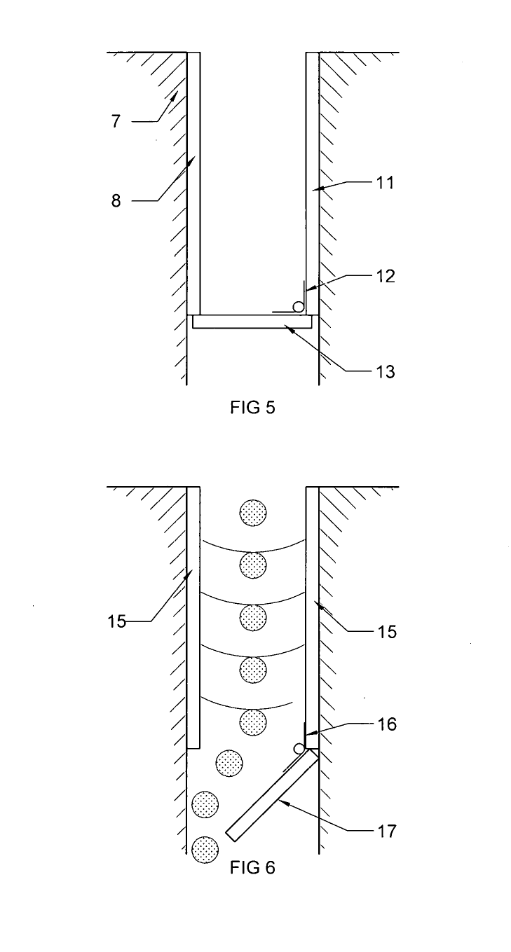

Referring to FIG. 6, the device is of a transparent view of the tube (15) inserted into the drain flange or pipe and the hinge (16) is extended allow the lid (17) to be separated from the tube (15). The water is for demonstration only to show how the lid (17) will separate from the tube to allow the mass (water) to escape.

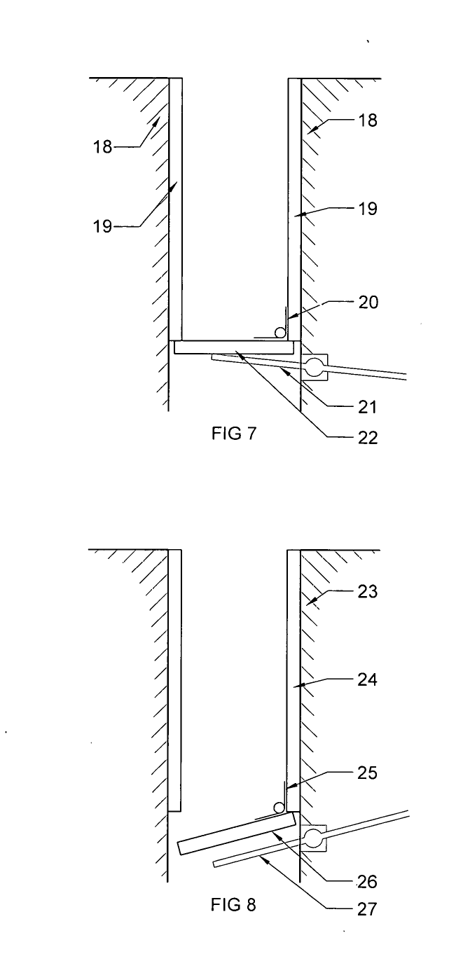

Referring to FIG. 7, the device is place inside a drain flange or pipe (18) that has a pivotal rod (21) in it to control the discharge of water flow. The tube (19) is placed inside the drain flange or pipe (18) and the lid (22) can be placed above the pivotal rod (21) so its pressing against the lid (22) to not allow the lid (22) to separate from the tube (19) even if there is enough mass to force open the hinge (20) under normal circumstances.

Referring to FIG. 8, the device is in a drain flange or pipe (23) and the tube (24) is inside of the drain flange or pipe (23) that allows the lid (26) to be above the pivotal rod (27), so if the pivotal rod (27) is in the open down position the hinge (25) is able to extend and open so the lid (26) can separate from the tube (24.)

Referring to FIG. 9, from a top dead centre view device has the tube (30) surrounding the inside of the drain pipe (28) so the lid (31) and the hinge (29) are visible, the hinge (29) can be used to line up and set the placement of the tube (30) over pivotal rod, if the user has a pivotal rod and wants to use it as a feature.

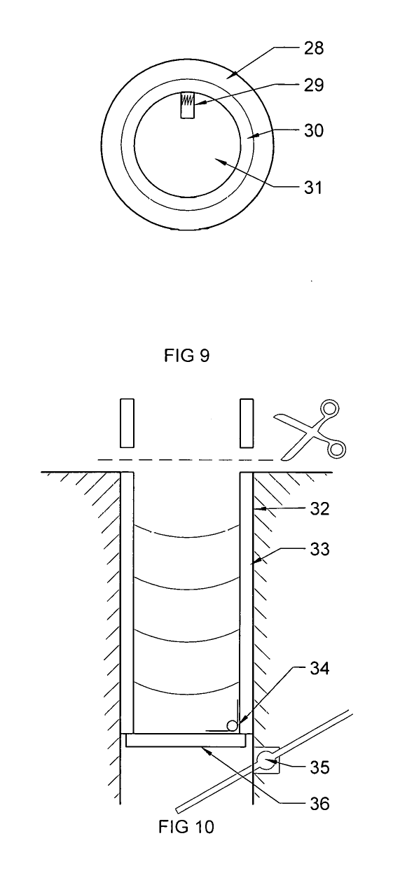

Referring to FIG. 10, the user of device can insert the tube (33) into the drain flange or pipe (32) and pushed down the tube (33) so the lid (36) is above the pivotal rod (35) and the hinge (34) can be placed over the pivotal rod's (35) opening of the drain flange or pipe (32.) This allows the pivotal rod (35) the ability to be used as a stopper to allow the drain to be open in both directions or to close one side. Once the tube (33) is in place inside the drain flange or pipe (32) the user can cut or firm any extra or additional material off the tube (33).

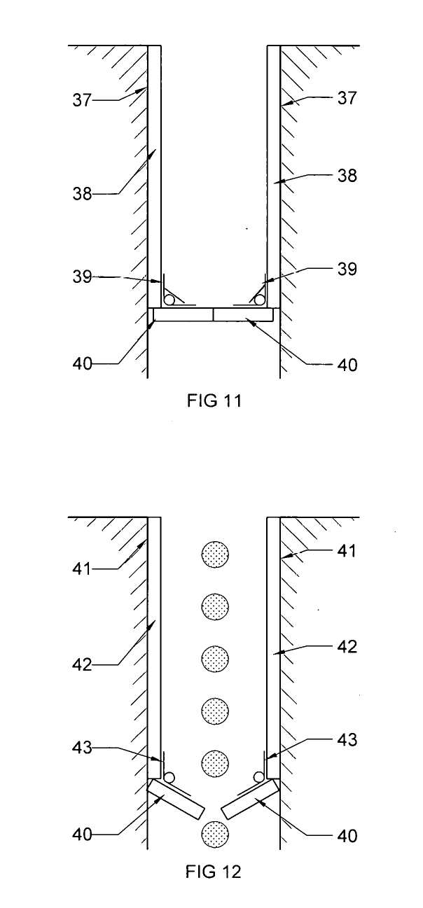

Referring to FIG. 11, the device has its tube (38) inserted into the drain flange or pipe (37) and the tube (38) is connected to multiple hinges covered by shields (39) in which the hinges (39) are connected to the lids (40). With multiple lids (40) closing together, the lids (40) connect to create a barrier to stop the insects/living creatures from passing. In FIG. 11, the device is in a closed position with its hinges (39) not extend and closed so the lids (40) form a untied barrier. For commercial and larger pipes, it might be necessary to add multiple hinges and lids to the device but the lids still form a united barrier to the one lid barrier.

Referring to FIG. 12, water is for demonstration purposes only, the device has its tube (42) inserted into the drain flange or pipe (41) and the tube (42) has two hinges (38) connected at its base and to the lids (44). When enough force is added to the lids (44) the hinges (43) extend and open to allow the lids (44) to separate from the tube (42.) This separation from the tube (42) lets the lids (44) open so the mass to escape and leave the tube (42) because the hinges (43) expanded.

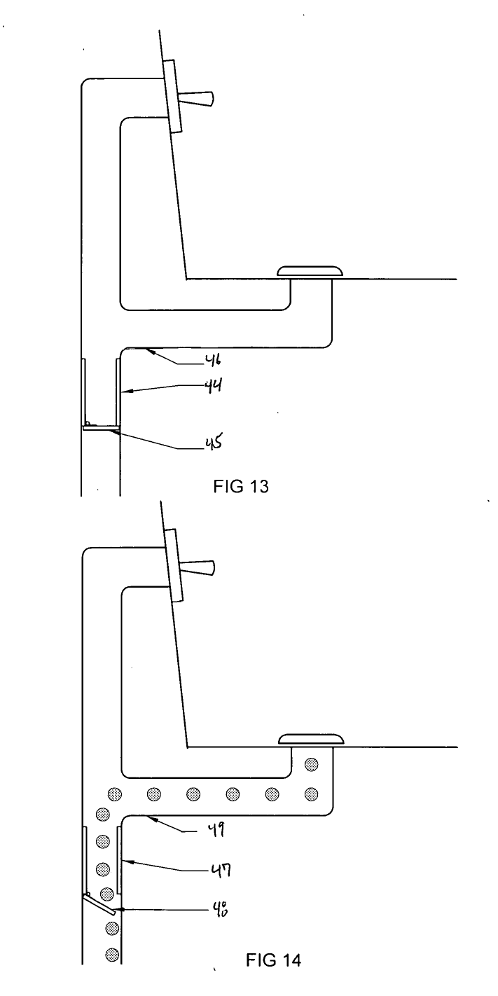

Referring to FIG. 13, the device has a tube (44) that is placed inside of a pipe (46) from a bathroom tub that has a closed lid (45) because there lacks any waste water pressure from the bathtub to open it.

Referring to FIG. 14, the device has a tube (47) that is placed inside of a pipe (49) from a bathroom tub that has an open lid (48) because the pressure from the waste water of the bathroom tub as opened it.

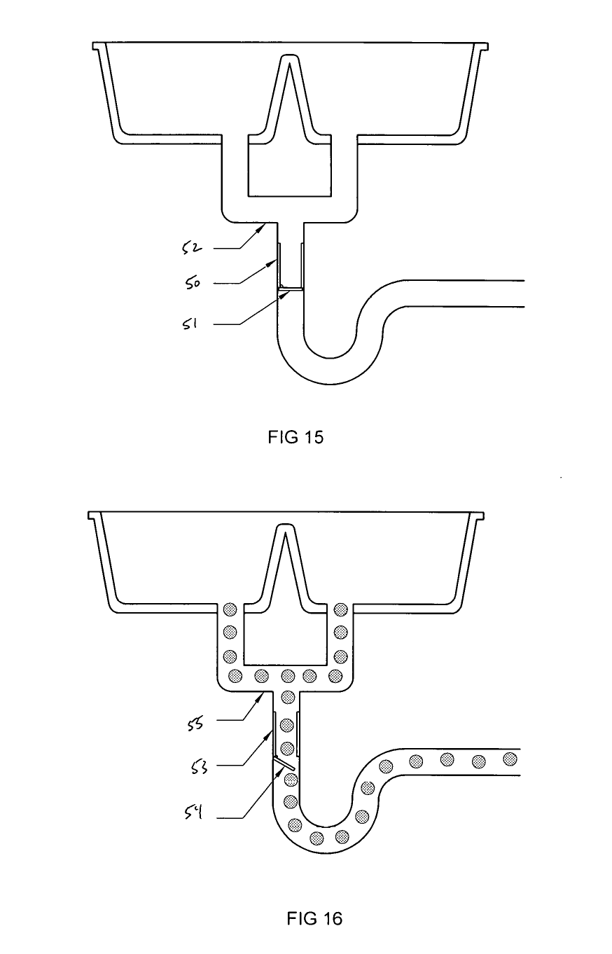

Referring to FIG. 15, the device has a tube (50) inside of the pipe (52) from a sink that has i is lid (51) closed.

Referring to FIG. 16, the device has a tube (53) inside of the pipe (55) from a sink that has its lid (54) open.

### My Invention has the Following Positive Attributes:

1. It does not use any harmful/toxic chemicals to reduce or eliminate the insects/living creatures.
2. It does not harm the humans and pets.
3. It is very easy to install, it only requires the customer to pick the right size of the device, remove the stopper or drain cap or any object in the drain's flange or tube or any plumbing fitting on the top of the pipe, if installed, and cut to fit (if desired.)
4. It is not harmful to the environment.
5. It works all day/night long to prevent or reduce the insects/living creatures because the lid remains closed.
6. It does not require electricity or power.
7. Its environmentally friendly and is a non-kill option for people who do not like to kill/hurt any living creature.
8. It helps catch and stop some types of objects from falling to the J-drain or pipe.
9. The device can help reduce or stop any bad sewer smells.
10. The device is easy to install, remove, and replace.

I claim:

1. A Pipe Self Closing Device comprising: a tube that can be inserted into a pipe with at least one hinge connected to the tube to form a lid at the bottom of the pipe that can act as barrier when closed and allow for mass or liquid to escape when opened.

2. The Pipe Self Closing Device according to claim 1, wherein the tube can be inserted inside any pipe.

3. The Pipe Self Closing Device according to claim 2, wherein the tube can be inserted inside any drain flange, drain tube, plumbing pipe, pipe, metal pipe, plastic pipe, pipes, plumbing pipes.

4. The Pipe Self Closing Device according to claim 1, wherein there is least one hinge that is connected to the tube at one end of the tube.

5. The Pipe Self Closing Device according to claim 1, wherein the hinge will move to expand and retract (open and close) the lid when enough pressure is placed upon the lid.

6. The Pipe Self Closing Device according to claim 1, wherein when the hinge that is attached to the tube is closed the lid that is attached to the hinge will also closed and it will touching the rim of the end of the tube to act as a barrier.

7. The Pipe Self Closing Device according to claim 1, wherein when the tube has more than one hinge attached to it, the hinges are attached to portions of lids that equal a full lid that when placed together in the closed position will create a unified barrier.

8. The Pipe Self Closing Device according to claim 1, wherein the hinge opens and allows the lid to separate from the tube when enough pressure of mass is placed upon the lid to cause the attached spring to expand.

9. The Pipe Self Closing Device according to claim 1, wherein the when the hinge is closed the attached lid touches the rim at the end of the tube and act as a barrier.

10. The Pipe Self Closing Device according to claim 1, wherein when there are more than one hinges that are contracted their attached portion of lids will be touching the rim at the end of the tube to act as a barrier by uniting together.

11. The Pipe Self Closing Device according to claim 1, wherein when enough pressure is applied to a tube with more than more lids when enough pressure is placed upon the lids, individually or collectively the lids will separate from the rim of the tube and stop acting as barrier.

12. The Pipe Self Closing Device according to claim 1, wherein further comprising: when the pressure leaves a tube with more than one lid on it, the hinges will retract themselves so the lids can close around the end of the tube to from a barrier.

13. The Pipe Self Closing Device, wherein said device can be placed inside the pipe at any location.

14. The Pipe Self Closing Device according to claim 13, wherein said device is place at the drain flange in the pipe.

15. The Pipe Self Closing Device according to claim 14, wherein if there is a proviral rod it can be used to press against the lid to close it or to be away from the lid to allow the lid to open.

16. The Pipe Self Closing Device according to claim 13, wherein said device is place anywhere inside the piping.
